(19) United States
(12) Patent Application Publication
(10) Pub. No.: US 2024/0289003 A1
(43) Pub. Date: Aug. 29, 2024

(54) Coastal Morphometrics Analysis Toolkit

(71) Applicant: Integral Consulting Inc., Seattle, WA (US)

(72) Inventors: Cheryl J. Hapke, St. Petersburg, FL (US); Timothy Robert Nelson, Clearwater, FL (US); Caleb Grant, Steilacoom, WA (US)

(73) Assignee: Integral Consulting Inc., Seattle, WA (US)

(21) Appl. No.: 18/115,299

(22) Filed: Feb. 28, 2023

(51) Int. Cl. G06F 3/04845; G06T 11/00

(52) U.S. Cl. CPC G06F 3/04845; G06T 11/00; G06F 2203/04806; G06T 2200/24

(57) ABSTRACT

The invention provides a method for displaying morphometrics via an interactive user interface, including the steps of receiving a coastal study that characterizes a section of a coastline on a specific date, maintaining a collection of transect data records which correspond to the received coastal study, calculating a set of morphometrics, receiving a request to display a selected morphometric for the coastal study, displaying a coastline viewer that enables a user to interactively view an image of the section of the coastline covered by the study, and displaying a morphometrics view that enables a user to interactively view the calculated morphometric.

### BACKGROUND

Coastlines change frequently due to weather, tidal action and other physical effects. The shape and growth characteristics of coastlines, including coastal dunes, beaches, offshore, and the coastline itself can be characterized using morphometrics.

Studies of the shape of coastlines are conducted using coastal morphometrics. The term morphometrics refers to the metrics used to conduct quantitative analysis of form, encompassing size and shape factors along coastlines. Thus, the term coastal morphometrics or simply morphometrics, as used herein, refers to the metrics used to conduct quantitative analyses of the shape and form of a coastal area. Specifically, it refers to the features that are used to characterize the state of a coastal area and to measure its historical changes.

While there is an increasing array of coastal data available, there is a lack of tools that provide interactive access to complex coastal data and which generate and display coastal morphometrics that can be used by researchers and coastal managers.

Thus, it is with respect to these considerations and others that the present invention has been made.

### SUMMARY OF THE DESCRIPTION

The invention is an interactive online dashboard toolkit that allows a user to easily visualize time series of coastal profiles, view along-coast variations and changes through time, with accompanying morphometric statistics.

The interactive approach improves upon existing coastal morphometric technology in several ways. First, it provides immediate, interactive access to a wide range of data, a capability that is not currently available from a single, unified interface. Second, it calculates morphometric statistics from underlying measured data that are readily understandable to researchers and coastal managers. Third, it offers a user interface that is specifically tailored to readily displaying coastal morphometrics. Thus, rather than offer a general dashboard-style access to datasets it constructs a user interface that is specifically geared to process and interactively display morphometrics that are required to understand a coastline and it's changes over time. Fourth, it provides a comprehensive toolkit that ingests coastal data and provides interactive and visual access to the data, thus streamlining the ability for researchers to access and exploit coastal data.

In certain embodiments, CMAT provides two views, a profile view in which basic measures along coastal transects are provided, and a morphometrics view that shows user-selected morphometrics related to one or more transects across multiple coastal sites. In both the profile view and the morphometrics view the displayed results are synced with a coastal map viewer that shows the specific section of a coastline under investigation.

In certain embodiments, the invention provide a method for displaying morphometrics via an interactive user interface, the method including the steps of receiving a coastal study, where a coastal study comprises data that characterizes a section of a coastline on a specific date, maintaining a collection of transect data records which correspond to the received coastal study, where a transect data record specifies information for a sequence of points along a transect, where a transect is a line segment perpendicular to the shoreline within the section of coastline, and where the information for each point comprises a location, an elevation, and a date, calculating a set of morphometrics, where the calculated morphometric is calculated for each coastal study and for each transect in the coastal study, maintaining a collection of morphometric data records, where each morphometric record includes data for a specific morphometric, receiving, via an interactive user interface running on a user computer, a request to display a selected morphometric for the coastal study, requesting the morphometric data record for the selected morphometric, displaying, by the interactive user interface, a coastline viewer that enables a user to interactively view an image of the section of the coastline covered by the study, wherein the coastline viewer displays each transect as a line segment overlaid on the image of the coastline; and displaying, by the interactive user interface, a morphometrics view that enables a user to interactively view the calculated morphometric.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 is a block diagram of an embodiment of coastline morphometrics system (CMS) 1 that compiles existing data about a coastline and makes the data available to a user through a coastline morphometrics analysis toolkit (CMAT).

FIGS. 2A-B illustrates an embodiment of a profile view provided by the coastline morphometrics analysis toolkit (CMAT).

FIGS. 3A-B illustrate an embodiment of an embodiment of a morphometrics view provided by the coastline morphometrics analysis toolkit (CMAT).

FIGS. 4A-B illustrate an embodiment of the software modules used to implement the coastline morphometrics analysis toolkit (CMAT).

FIG. 5 illustrates one embodiment of a method performed by the CMAT to generate a morphometrics view.

Reference symbols and labels are used in the Figures to indicate certain components, aspects or features shown therein, with reference symbols and labels common to more than one Figure indicating like components, aspects or features shown therein.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods or devices. Accordingly, the present invention may take the form of an entirely hardware embodiment, an entirely software embodiment or an embodiment combining software and hardware aspects. The following detailed description is, therefore, not to be taken in a limiting sense.

As used herein the following terms have the meanings given below:

Transect—refers to a line that runs perpendicular to the shore at a particular point. Coastline data is provided for parallel transects which are generally at regular spatial intervals, e.g. every 10 feet. As used herein, the term transect and the term profile refer to the same line segment; however, profile refers to side views of the coastal area while transect is used when the coastal area is viewed from above.

Coastal morphometrics or morphometrics—as used herein refers to coastal metrics or statistics that relate to one or more transects. These metrics are typically used to conduct quantitative analyses of the shape and form of a coastal area.

The following discussion focuses on the use of CMAT for analyzing coastlines, but it can also be applied to other geographic areas such as lakes, deserts, and mountains.

The invention is a toolkit used to interactively view and analyze coastline data, including transect data and morphometrics. The technology seeks to provide a consistent user interface that enables a coastal researcher or manager to quickly and intuitively access, compare, and analyze large amounts of collected data. The tool's focus is on analysis of coastline data and on providing the ability to compare key metrics visually and interactively. Metrics are compared with respect to spatial locations, i.e. transects, and across time.

### Generalized Operation

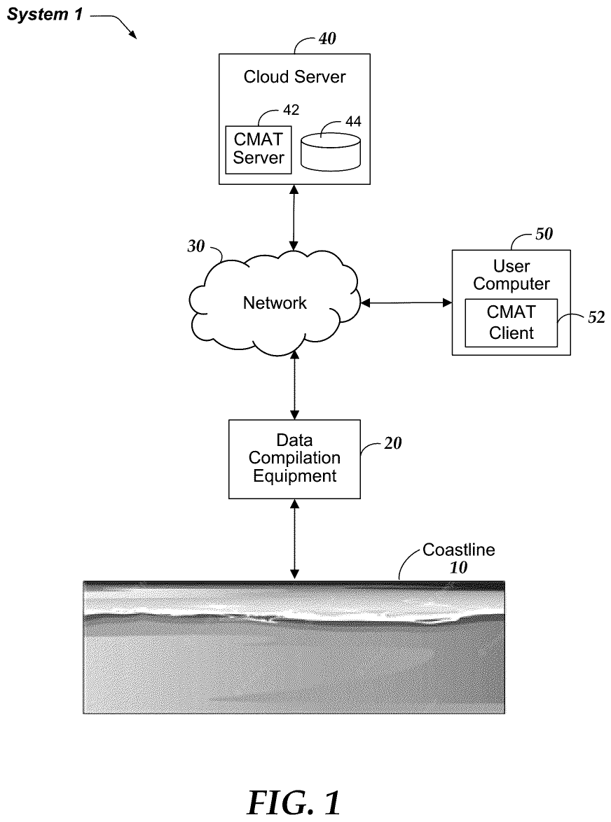

The operation of certain aspects of the invention is described below with respect to FIGS. 1-5.

FIG. 1 is a block diagram of an embodiment of coastline morphometrics system (CMS) 1 that compiles data about a coastline and makes the data available to a user through a coastline morphometrics analysis toolkit (CMAT) 42,52. CMS 1 includes a coastline 10 being analyzed, a suite of data compilation equipment 20, a network 30, a cloud server 40, and a user computer 50. In certain embodiments, CMAT is implemented as a server component 42, referred to as CMAT server 42, and a client component 52, referred to as CMAT client 52.

Cloud server 40 refers to one or more network computing devices that are configured to receive digitized sensor data across network 30 from data compilation equipment 20, to store and maintain the data using a CMAT data store 44, and to provide the data upon request to CMAT 52, operating in user computer 50.

Devices that may operate as cloud server 40 include, but are not limited to server computers, personal computers, desktop computers, multiprocessor systems, microprocessor-based or programmable consumer electronics, network PCs, servers, network appliances, and the like. Generally, cloud server 40 includes a processor, and static memory for storing data and program code, dynamic memory, and data store 44. Cloud server 40 includes a communications adapter that enables it to transmit and receive data across network 30. As used herein, data store 44 refers to software that manages the storage process. It is understood that cloud server 40 either includes or provides access to physical storage devices as well; thus, unless otherwise specified the term data store as used herein refers to the software for accessing physical storage and to the physical storage itself.

Although cloud server 40 is illustrated as a distinct network device, the invention is not so limited. For example, a plurality of network devices may be configured to perform the functions of cloud server 40. One such configuration is a “server farm” that includes multiple server computers operating cooperatively, each performing some of cloud server 40 server functions. Further, cloud server 40 functions may also be provided by a cloud computing facility, or cloud service, in which the services, features and functions ascribed herein to cloud server 40 are delivered as a service over network 30. Examples of commercial cloud services are AMAZON AWS, MICROSOFT AZURE, and GOOGLE CLOUD.

Cloud server 40 is capable of running application programs (“applications”). Applications that may be run by cloud server 40 include transcoders, database programs, customizable user programs, security applications, encryption programs, VPN programs, web servers, applications servers, account management systems, and so forth.

As described hereinbelow, in certain embodiments, CMAT server 42, running in cloud server 40, performs partial processing, or ingest, of raw data provided by data compilation equipment 20. Upon request, it then and provide the results user computer 50. In other embodiments, cloud server 40 simply stores raw, or processed, data and provides it, upon request, to user computer 50 for processing by CMAT client 52.

Generally, embodiments of user computer 50 include any computing device capable of receiving and sending messages over a network, such as network 30, and which can be programmed to process shoreline data stored on cloud server 40. User computer 50 may be a personal computer, server computers, multiprocessor systems, microprocessor-based or programmable consumer electronics, mobile devices such as mobile telephones, smart phones, display pagers, tablet computers, handheld computers, laptop computers, and the like.

Network 30 is configured to couple user computer 50, cloud server 40 and data compilation equipment 20. Network 30 may include the Internet in addition to local area networks (LANs), wide area networks (WANs), direct connections, and combinations thereof or the like.

### Data Compilation

A wide variety of equipment and processes can be utilized as data compilation equipment 20 to ingest raw data that characterizes coastline 10. Examples include land and aerial photographic devices, sonar, lidar, sediment analysis devices, surficial sediment sampling devices, and semi-quantitative X-ray diffraction mineralogy devices.

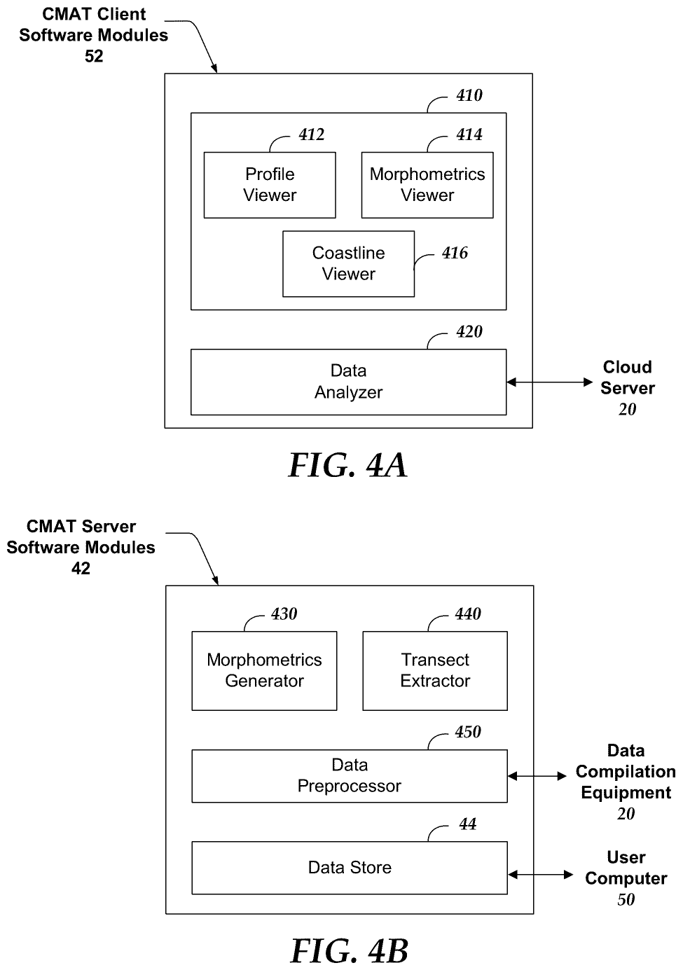

CMS 1 supports a number of processing embodiments: generally, processing steps can be flexibly assigned between CMAT server 42 and CMAT client 52. In certain embodiments, data compilation equipment 20 provides digitized raw sensor data via network 30 to cloud server 40. In certain embodiments, cloud server 40 provides the raw data to user computer 50 via network 40. In such embodiments, CMAT client 52, operating in user computer 50, processes the raw data to generate morphometrics for display to the user. In other embodiments, CMAT server 42 performs some or all of the processing to generate morphometrics for display. One embodiment of the assignment of functions between CMAT server 42 and CMAT client 52 is described with reference to FIGS. 4A and 4B with the understanding that other allocations of functions between the client and server modules are within the scope and spirit of the subject invention.

### Profile View

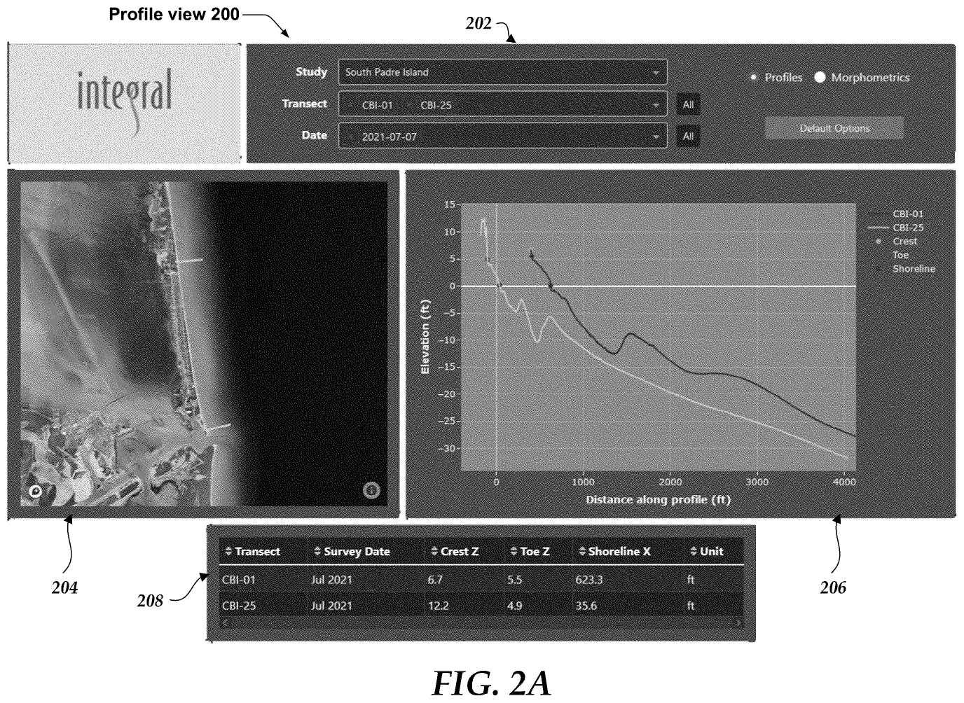

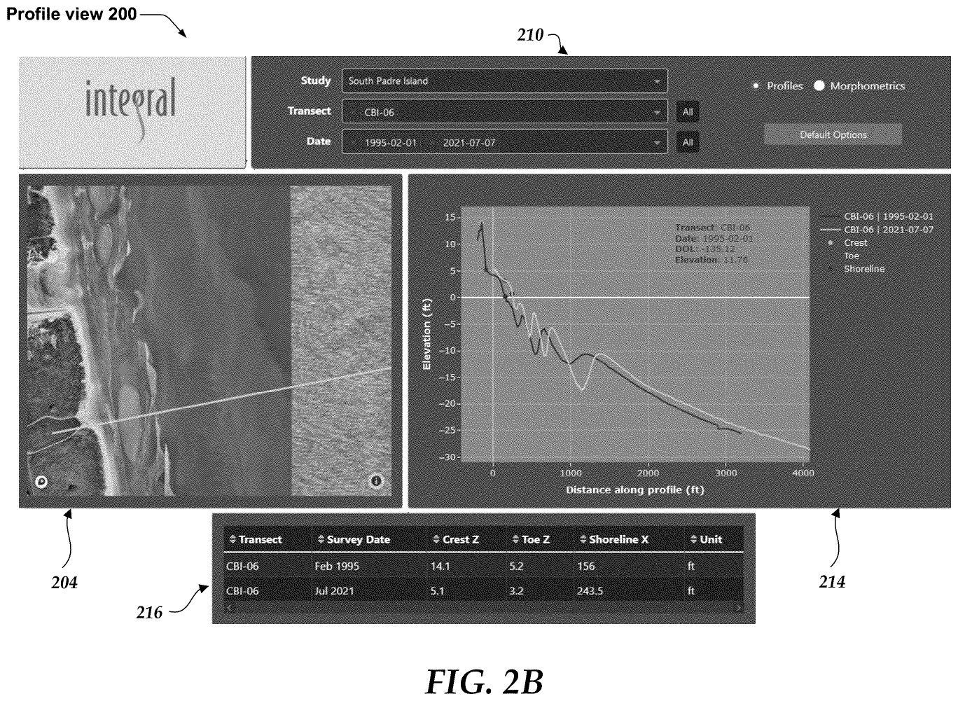

CMAT provides two user interfaces: a profile view 200 and a morphometrics view 300. FIGS. 2A-2B are embodiments of profile view 200. Profile view 200 features four interactive panels: control panel 202, coastline viewer 204, profile panel 206, and transect panel 208.

Control panel 202 is used to (1) select a data set, referred to as “Study”, for analysis, (2) select one or more transects for analysis, and (3) select a date or range of dates for analysis. Control panel 202 is also used to select whether to operate in profile view or morphometrics view.

Coastline viewer 204 is used to select one or more transects for analysis and to interactively view a high-resolution photo or map of the coastline under analysis. As depicted in FIG. 2A two transects are selected; these are indicated by line segments that jut into the ocean perpendicular to the coastline.

Coastline viewer 204 provide a variety of interactive viewing features. For example, Hovering over the map will display a toolbar on the top right corner. The toolbar contains buttons to zoom in/out, scroll, download the map, and reset the current view.

Profile panel 206 shows the elevation along each of the selected transects. The y axis gives the elevation of the coast at each point, x, along the transect. The x axis gives the distance from the shore, where the shore is considered to have the value 0,0, i.e. zero feet above sea level at the origin point of the transect, i.e. at the shoreline. Negative x values correspond to ft, or meters, onto the shore, i.e. away from the ocean.

Transect panel 208 displays key features for each selected transect. In the example of FIG. 2A two transects have been selected, CBI-01 and CBI-25. In this example, CBI-01 is the southernmost transect in the study area and CBI-25 is the northernmost transect. The data shown is from a July 2021 survey. The high point, referred to as crest z, or dune crest, of CBI-01 occurs at 6.7 feet from the ocean and the dune crest of CBI-25 occurs at 12.2 feet. Other data provided in this view is toe z, and shoreline x. Shoreline refers to the distance of the start of the dune or sandy beach from the coastline, i.e., from the origin point.

FIG. 2B illustrates another example of the use of profile view 200. In this example, a single transect, CBI-06, is selected using profile panel 210. However, two different studies are selected, the earliest study, conducted on Feb. 1, 1995, is selected, as is the most recent study, Jul. 7, 2021. Here the objective is to compare the beach condition with respect to a single transect over time. Coastline viewer 204 shows the single selected transect, CBI-06. Profile panel 214 shows two curves, one for each study date. Each curve shows the respective elevations at points along the transect for the study date. This provides an easy way to compare the coastline along that transect at the respective dates. For example, it is immediately apparent that in 1995 there was a dune on the shore with a dune crest of 14.1 feet. While the 2021 profile shows that the dune is substantially lower and that the dune crest is then at 5.1 feet. Note that the data inside the graph area labeled Transect, Date, DOL, Elevation corresponds to location of the cursor (the cursor itself doesn't appear in FIG. 2B however).

Upon further analysis, using the zoom tool to zoom into the beach area, it becomes apparent that in 2021 there are two paths that reach the beach where the dune was located in 1995; it may be supposed that construction of these paths was at least partially responsible for near elimination of the dune.

Transect panel 216 gives crest, toe, and shoreline values for each of the two studies. These values are typically estimated from the underlying data captured as part of the study.

It may be appreciated that FIG. 2B provides just one real-world example of how profile view 200 may be used. CMAT 60 is entirely flexible and can be used for a wide variety of comparisons. For example, any number of transects may be selected and any number of studies may be selected. Further, the profile data is typically available for 3000 to 5000 feet from the shoreline. Thus, it is possible to compare underwater elevations over time.

### Morphometrics View

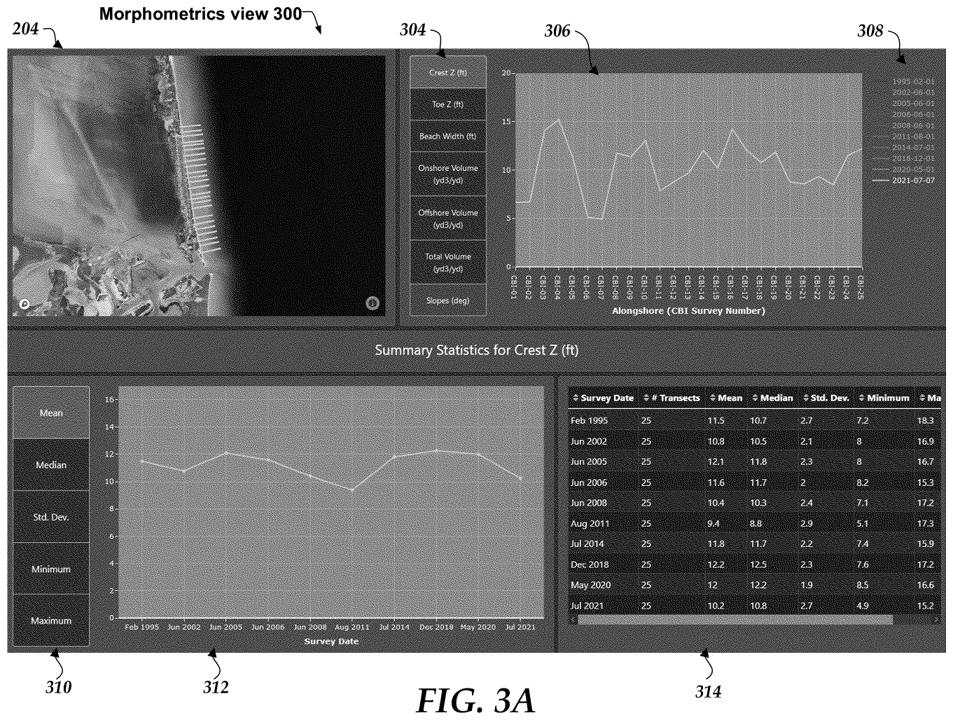

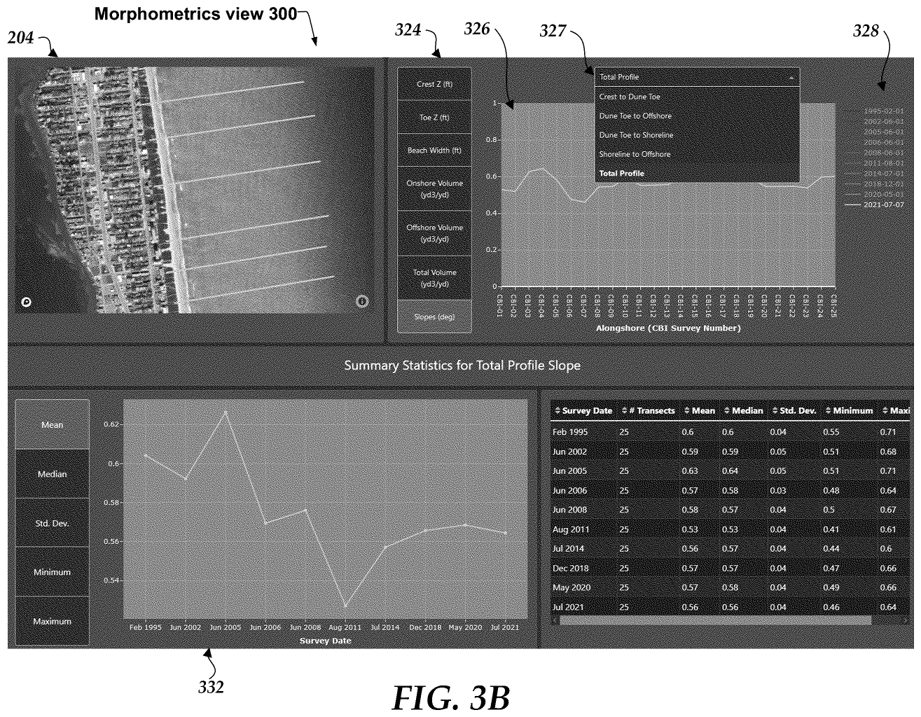

FIGS. 3A-3B are embodiments of morphometrics view 300. Morphometrics view 300 features seven interactive panels; illustrated in FIG. 3A, the panels include coastline viewer 204, and several panels that are customized to interactive viewing of morphometric data, namely morphometric selector 304, profile panel 306, study selector 308, statistic selector 310, statistics panel 312, and statistic table 314.

Coastline viewer 204 shows a photo or map of the coastline being studied. Each of the transects available in the study are shown, i.e. the lines perpendicular to the coastline jutting into the ocean. When a cursor is placed in profile panel 306 the nearest transect is indicated by coastline viewer 204, for example, by changing its color.

Morphometric selector 304 enables the user to select one or more morphometrics to study. The information displayed in profile panel 306, statistics panel 312 and statistics table 314 pertain to the selected morphometric. The morphometrics available in morphometric selector 304 are those of most common interest from researchers and coastal managers. They are: crest Z, toe Z, beach width, onshore volume, offshore volume, total volume and slopes. Other statistics can be shown as well. In the example of FIG. 3A, crest Z, i.e. the highest elevation on the beach along a transect is selected. While there may be slight differences in definitions between different coastal researchers and coastal managers, the definitions used for the morphometrics available in morphometric selector and which are calculated by CMAT 60 are given in Table 1, below.

TABLE 1
Definition of Morphometrics

| | |
|---|---|
| crest Z | the highest elevation on the seaward most portion |
| | of a dune system |
| toe Z | The point of maximum curvature between the |
| | shoreline and the dune crest |
| beach width | The distance from the shoreline to the dune toe |
| | along a transect |
| onshore volume | For a one yard (or 1 meter or 1 foot, etc.) wide |
| | swath along a transect to a predetermined |
| | distance onshore, e.g. 50 feet, the volume of sand |
| | or other material above the water surface |
| | elevation. In other embodiments, the swath along |
| | the transect halts at the dune crest or at an |
| | established survey marker. |
| offshore volume | For a one yard (or 1 meter or 1 foot, etc.) wide |
| | swath along a transect to a preset distance |
| | offshore, e.g. 1000 feet, the volume of sand |
| | between a predetermined depth and a vertical line |
| | extended to that depth from the position of the |
| | shoreline. |
| total volume | Total of onshore volume and offshore volume. |
| slope | The slope, y/x, between two onshore features |
| | along a transect; e.g., between the crest and the |
| | toe, toe and shoreline, or total profile slope. |

Profile panel 306 shows a profile or curve for a study selected in the adjacent study selector 308. In the example, the y axis gives the elevation of the dune crest for a particular transect and the x axis gives the sequence of transects, i.e. the sequence of locations along the beach.

Statistic selector 310 selects the type of statistic to be illustrated in the adjacent statistics panel 312. In the example of FIG. 3A, the mean is selected. Thus, statistics panel 312 shows the average dune crest across all studies, i.e. from February 1995 to July 2021. Alternatively, the user can use selector 310 to select a median, a standard deviation, a minimum or a maximum value to be displayed for each study in display 312. The underlying data points used to generate statistics panel 312 is shown in statistics table 314.

The ability to compare different morphometrics over time is an invaluable tool to understanding what happens to a coastline. It enables phenomenon such as beach erosion, or storm impact, to be studied both visually and quantitatively. For example, following a storm it might be possible to observe that a large quantity of sand was moved from the shoreline to just offshore. In another, example, if a significant amount of sand is lost from the beach and it is desired to “renourish” the beach by adding sand back; the onshore volume morphometric can be used to determine how much sand must be added back to reach a previous level.

Note that the statistic selected in selector 310 is applied across all transects for each study for both statistics panel 312 and statistics table 314. Therefore, statistics panel 312 always shows a single curve.

FIG. 3B shows an embodiment of morphometrics view 300 in which the Slopes morphometric is selected using morphometric selector 324. A slope menu 327 may be used to select among several different slopes. Each slope is measured between two different points on a transect to provide a different understanding of how the slope varies along the transect. The menu options are (Dune) Crest to Dune Toe, Dune Toe to Offshore, Dune Toe to Shoreline, Shoreline to Offshore, and Total Profile, which is the slope from the Dune Crest to the furthest point measured along the transect offshore. It may be appreciated that coastal viewer 320 has been zoomed in to show significant detail about the shoreline.

Study selector 328 has selected the most recent, 2021, study, which is shown in profile panel 326. Below, the mean value of the total profile slope across all studies appears in statistic display 332.

FIGS. 4A-B illustrate one embodiment of the software modules that together implement the coastline morphometrics analysis toolkit (CMAT). The software modules are partitioned into CMAT server 42 software modules and CMAT client 52 software modules. FIG. 4A illustrates one embodiment of the software modules in CMAT client 52. User interface module 410 receives transect data and morphometrics data from data analyzer 420 and displays visual results as interactively requested by a user. Module 410 has three major components: profile viewer 412, morphometrics viewer 414 and coastline viewer 416. Profile viewer 412 generates the profile view displays described with reference to FIGS. 2A-B. Morphometrics viewer 414 generates the morphometrics view displays described with reference to FIGS. 3A-B. Coastline viewer 416 interactively generates views of the coastline described with reference to both FIGS. 2A-B and FIGS. 3A-B.

Data analyzer 420 requests transect data and morphometrics data from cloud server 20 as required to generate a display being requested by a user. Transect data characterizes a segment of a coastline at a particular date, or date and time by providing data for each transect included in the coastline segment. Thus, when the user is viewing a profile view 200 display data analyzer 420 requests the necessary underlying transect data. Data analyzer 420 requests transect data for each transect selected for display in profile panel 206 and requests key transect feature data, including crest, toes and shoreline values for display in transect panel 208

FIG. 4B illustrates one embodiment of the software modules in CMAT server 42. Data preprocessor 450 receives transect or profile data from data compilation equipment 20. Data preprocessor 450 extracts transect data and generates a record for each datapoint in each transect. In certain embodiments, a transect data record includes the elements for each point in a transect, as given below in Table 2.

TABLE 2
Transect Data

| Name of data element | Brief description |
|---|---|
| transect_id | unique identifier |
| date & time | Date and time of the study |
| x_coord | X coordinate (e.g., longitude) |
| y_coord | Y coordinate (e.g., latitude) |
| srid | spatial reference identifier |
| elevation_datum | elevation value |
| elevation_units | elevation units |
| dol | distance along profile (transect) line |
| dol_units | dol units |

The transect_id is a unique identifier that is assigned or automatically generated, (e.g.: Transect_01). A transect has a relatively fixed geographic location and often contains repeated surveys on different days/years.

Date & time refers to the date and time the data was captured and has a standard format such as yyyy-mm-dd, hh-mm-ss. In certain embodiments only a date is included.

The geographic location of each survey point along the transect is defined by the x_coord, y_coord, and srid, where x_coord is either the easting component in utm coordinate or longitude, while the y_coord is northing or latitude.

The srid defines the spatial reference system, or coordinate reference system, being used. For example, one reference system is given as the European Petroleum Survey Group (EPSG) Geodetic Parameter Dataset value, as defined at https://epsg.io/.

The numerical elevation of the survey point corresponds to each geographic coordinate and the corresponding units (elevation_units) and elevation datum (elevation_datum) are provided for each survey point.

Distance along the profile line (dol) and the corresponding units (dol_units) corresponds to the distance from an origin point. The origin point is a point along a transect that is considered as the origin. Typically, positive values indicate distance from the origin to a point offshore and negative values indicate a distance from the origin to a point onshore. The origin point is typically defined by the surveyors that performed the first study of a coastal segment.

Transect data as described above is stored by a data store 44 module. Data store 44 may be a single relational database, a file system in which discrete files are stored, a network storage or cloud storage in which the physical storage media is accessed across a network. Generally, data store 44 stores and maintains transect data and morphometric data and provides it, on request, to user computer 50.

The key transect features shown in transect panel 208, namely dune crest, dune toe, and shoreline, are extracted by transect extractor 440, which in certain embodiments is implemented using a python package named pybeach (further information about pybeach can be found at https://github.com/TomasBeuzen/pybeach).

In certain embodiments, transect extractor 440 enforces a number of constraints to ensure data consistency, including (1) ensuring that the survey point identifying the shoreline is above or equal to a user selected, or default, shoreline elevation (e.g.: mean high-water or mean sea-level), (2) ensuring that the dune toe is shoreward of the dune crest and landward of the shoreline, and (3) ensuring that each feature is at a unique survey point. If any of these conditions is not met, a not-a-number value is set to prevent the erroneous value from being used in further calculations. This is repeated for each transect_id and each survey date.

Morphometric data, used by morphometrics viewer 414 is calculated from the transect data, described above. Data analyzer 420 uses a morphometrics generator 430 module to perform the necessary calculations to generate the morphometrics data.

In certain embodiments, all morphometric data is computed when a new study is received by cloud server 40 and then stored in data store 44. In this case, once coastal data is received from data compilation equipment 20 data preprocessor 450 generates corresponding transect data and stores it in data store 44. Then morphometrics generator 430 generates all morphometrics and stores these using data store 44.

Using the identified shoreline, morphometrics generator 430 calculates the volume along profile (unit3/unit). For consistency among transect_id, the extents are limited to ensure the profiles have the same landward extent relative to the dune crest and landward 10 feet or to start of profile. The offshore extent is limited to the highest of the minimum elevation for each transect at the first offshore crossing of this contour. All volumes are referenced to volume above this reference contour. To ensure positive volume, this contour value is added to the elevation such that no negative values remain. Three volumes are calculated: volume of material above a user defined shoreline elevation, volume below the user defined shoreline elevation, and the total volume of the profile. It may be appreciated that while a shoreline may be expected to have a zero elevation, because the shoreline segment is analyzed over a period of time and at different times of day the shoreline value can change; so a user defined value or default value is required.

The elevation profile slopes metrics are calculated from the distance along line (dol) and the elevation of the identified dune crest, dune toe, and shoreline, as well as the furthest extent of the profile. Slopes calculated include the slope from the dune crest to the dune toe, dune crest to offshore, dune toe to shoreline, dune toe to offshore, and shoreline to offshore. In certain embodiments, the lowest offshore elevation along a transect is used when calculating an offshore slope, i.e. when calculating dune crest to offshore, dune toe to offshore, and shoreline to offshore.

Outliers in the detected metrics along each profile are detected using a zscore calculation using 2 standard deviations. These points are flagged and set to not-a-number value. The morphometric features are compiled into a coma-separated-value (csv) table indexed by the transect_id and date. The profile dataset and the morphometric dataset are then provided to the GUI CMAT interface, for example, using a python package plotly (https://github.com/plotly/plotly.py) which displays elevation profiles, transects, and temporal and spatial morphometrics for analysis. The average and standard deviation along transects and time are calculated within the plotly dashboard depending on the user-specified selections.

### Overall Processing Method

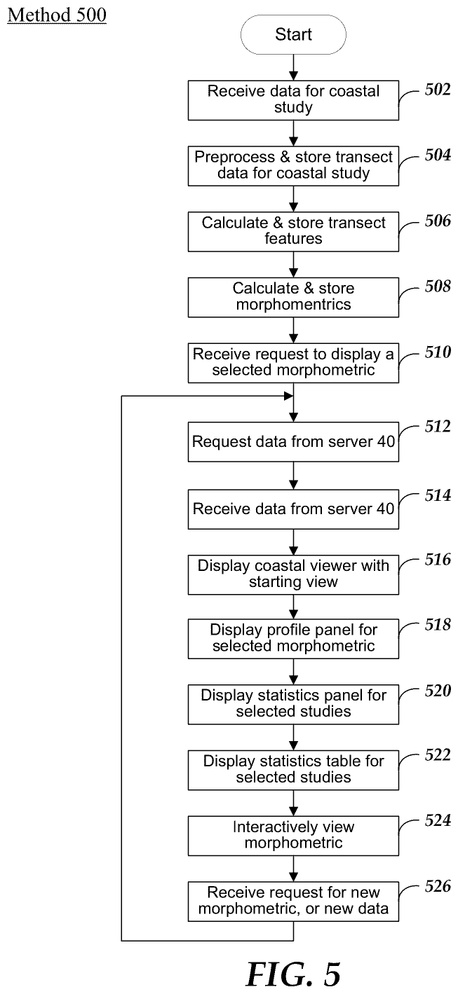

FIG. 5 is a flow diagram of one embodiment of the overall processing steps performed by CMAT 60 when the users enter morphometric view 300.

At step 502 coastal data for a new coastal study, which includes data for a segment of a coastline, is received by cloud server 40. Raw coastal data is typically received by data compilation equipment 20 and transmitted across network 30 to cloud server 40. In certain embodiments, coastal data may be provided from other sources, such as existing repositories of coastal data.

At step 504 the study data is preprocessed, if necessary, into a desired transect data format, where records in a specific data format are created for each transect included in the coastal study. The transect data is then stored by cloud server 40 using data store 44. In certain embodiments, the study data is received in the desired format and preprocessing is not performed prior to storing the transect data.

At step 506 the transect features shown in transect panel 208, namely crest, toe and shoreline, are extracted for each transect in the new study. The extracted feature data is then stored using data store 40.

At step 508 CMAT 42 calculates morphometric values for all transects across all studies. The morphometric data is then stored by cloud server 40 using data store 44. It may be appreciated that in other embodiments the morphometric values are calculated on demand, i.e. only after a user requests a display of the morphometric using statistic selector 310.

At step 510 a request is received for a selected morphometric. This selection is typically made by a user while using morphometrics view 300. In other cases, a default selection of studies and transects may be used. For example, this may occur upon start-up of CMAT 52 or when a user switches from profile view 200 to morphometrics view 300.

At step 512 CMAT 52 requests a selection of data from cloud server 40. CMAT 52 requests data as necessary to display the morphometrics and coastal views required by the selection.

At step 514 CMAT 52 receives the data it requested from cloud server 40 in the preceding step.

At step 516, CMAT 52 displays coastal viewer 204. Typically, the starting view shows the section of the shoreline that includes all transects in each of the coastal studies being investigated. Each transect appears as a line segment overlaid on the displayed map.

At step 518 the profile panel 306 for the selected morphometric is displayed.

At step 520 the statistics panel 312 for the selected morphometric is displayed.

At step 522 the statistics panel 314 for the selected morphometrics, studies and transects is displayed.

At step 524 the user interactively views the various panels in the morphometrics view 300 display. The user can interactively view the coastline using coastline viewer 204 and can interactively view morphometric data using the other panels available in morphometrics view 300.

Essentially, certain user interactions with morphometrics view 300 require generation of new views of the underlying transect and morphometrics data. At certain points the user interaction may require additional data. This is determined by data analyzer 420 which determines if additional transect data must be requested from cloud server 40 or if new morphometric data must be computed by morphometrics generator 430. For example, zooming in to coastal viewer 204 or selecting a new morphometric may generate a request for more data.

At step 526 if the user interaction results in a request for a new morphometric, or new coastal data such as a new study or a new selection of transects then control returns to step 512 where the new data is requested.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A method for displaying morphometrics via an interactive user interface, comprising;
receiving by a server computer, a coastal study, wherein a coastal study comprises data that characterizes a section of a coastline on a specific date;
maintaining, by the server computer, a collection of transect data records which correspond to the received coastal study, wherein a transect data record specifies information for a sequence of points along a transect, wherein a transect is a line segment perpendicular to the shoreline within the section of coastline, and wherein the information for each point comprises a location, an elevation, and a date;
calculating a set of morphometrics, wherein the calculated morphometric is calculated for each coastal study and for each transect in the coastal study;
maintaining, by the server computer, a collection of morphometric data records, wherein each morphometric record includes data for a specific morphometric;
receiving, via an interactive user interface running on a user computer, a request to display a selected morphometric for the coastal study;
requesting the morphometric data record for the selected morphometric;
displaying, by the interactive user interface, a coastline viewer that enables a user to interactively view an image of the section of the coastline covered by the study, wherein the coastline viewer displays each transect as a line segment overlaid on the image of the coastline; and
displaying, by the interactive user interface, a morphometrics view that enables a user to interactively view the calculated morphometric.

2. The method of claim 1, wherein maintaining the collection of transect data records comprises:
preprocessing the coastal study data to generate the transect data records; and
storing the transect data records.

3. The method of claim 1 wherein the coastline viewer initially displays a section of the coastline covered by the coastal study and interactively viewing an image comprises the ability for a user to zoom in, zoom out, and pan the image.

4. The method of claim 1 wherein the set of morphometrics includes at least one morphometric selected from the group consisting of a crest, a toe, a beach width, an onshore volume, an offshore volume, and a slope.

5. The method of claim 1 wherein the morphometrics view includes a profile viewer that shows the value of the calculated morphometric for each transect for selected coastal studies, wherein the calculated morphometric values are represented as a discrete line for each selected coastal study in which the x values are adjacent transects and the y values are the calculated morphometric values.

6. The method of claim 5 wherein said interactive viewing of the selected morphometric comprises visually identifying a corresponding transect in the coastal viewer to a point displayed in the profile viewer that is designated by the user.

7. The method of claim 6 wherein the morphometrics view comprises a statistics panel that displays the value of the calculated morphometric across all transects for each coastal study.

8. The method of claim 7 wherein the morphometrics view enables a user to select the type of statistic to be calculated and illustrated in the statistics panel, wherein the type of statistic includes at least one of the group consisting of a mean, a median, a standard deviation, a minimum and a maximum.

9. The method of claim 1 wherein the morphometrics view comprises a statistics table that displays a plurality of calculated morphometric statistics for each survey date, wherein each of the plurality of calculated morphometric statistics is selected from the group consisting of a mean, a median, a standard deviation, a minimum and a maximum.

10. The method of claim 4 wherein if slope is selected as the calculated morphometric then an additional selection of types of slopes is offered to the user wherein at least one of types of slopes are selected from the group consisting of dune crest to dune toe, dune toe to offshore, dune toe to shoreline, shoreline to offshore, and total profile, wherein total profile is the slope from the dune crest to the furthest point measured along the transect offshore.

11. A system for displaying morphometrics via an interactive user interface, comprising;
a server computer programmed to:
receive a plurality of coastal studies, wherein a coastal study comprises data that characterizes a section of a coastline on a specific date;
generate a collection of transect data records, each transect data record corresponding to a received coastal study, wherein a transect data record specifies information for a sequence of points along a transect, wherein a transect is a line segment perpendicular to the shoreline within the section of coastline, and wherein the information for each point comprises a location, an elevation, and a date;
maintain the collection of transect data records;
calculate a set of morphometrics, wherein the calculated morphometric is calculated for each coastal study and for each transect in the coastal study;
maintaining collection of morphometric data records, wherein each morphometric record includes data for a specific morphometric; and
receive from a user computer a request to display a selected morphometric for the coastal study;
a user computer, coupled across a network to the server computer, programmed to:
request the morphometric data record for the selected morphometric;
display, via an interactive user interface, a coastline viewer that enables a user to interactively view an image of the section of the coastline covered by the study, wherein the coastline viewer displays each transect as a line segment overlaid on the image of the coastline; and
display, by the interactive user interface, a morphometrics view that enables a user to interactively view the calculated morphometric.

12. The system of claim 11, wherein generating the collection of transect data records, comprises:
preprocessing the coastal study data for each received coastal study to generate a transect data record for each record in the study.

13. The system of claim 11 wherein the coastline viewer initially displays a section of the coastline covered by the coastal study and interactively viewing an image comprises the ability for a user to zoom in, zoom out, and pan the image.

14. The system of claim 11 wherein the set of morphometrics includes at least one morphometric selected from the group consisting of a crest, a toe, a beach width, an onshore volume, an offshore volume, and a slope.

15. The system of claim 11 wherein the morphometrics view includes a profile viewer that shows the value of the calculated morphometric for each transect for selected coastal studies, wherein the calculated morphometric values are represented as a discrete line for each selected coastal study in which the x values are adjacent transects and the y values are the calculated morphometric values.

16. The system of claim 15 wherein said interactive viewing of the selected morphometric comprises visually identifying a corresponding transect in the coastal viewer to a point displayed in the profile viewer that is designated by the user.

17. The system of claim 16 wherein the morphometrics view comprises a statistics panel that displays the value of the calculated morphometric across all transects for each coastal study.

18. The system of claim 17 wherein the morphometrics view enables a user to select the type of statistic to be calculated and illustrated in the statistics panel, wherein the type of statistic includes at least one of the group consisting of a mean, a median, a standard deviation, a minimum and a maximum.

19. The system of claim 11 wherein the morphometrics view comprises a statistics table that displays a plurality of calculated morphometric statistics for each survey date, wherein each of the plurality of calculated morphometric statistics is selected from the group consisting of a mean, a median, a standard deviation, a minimum and a maximum.

20. The system of claim 14 wherein if slope is selected as the calculated morphometric then an additional selection of types of slopes is offered to the user wherein at least one of types of slopes are selected from the group consisting of dune crest to dune toe, dune toe to offshore, dune toe to shoreline, shoreline to offshore, and total profile, wherein total profile is the slope from the dune crest to the furthest point measured along the transect offshore.
